(19) United States
(12) Patent Application Publication
(10) Pub. No.: US 2010/0063860 A1
(43) Pub. Date: Mar. 11, 2010

(54) Method for managing a business process related to a document publishing project

(75) Inventors: Kirk P. Gallion, Pottstown, PA (US); Donald G. Palmer, Coatesville, PA (US); Richard M. Lewis, Cochranville, PA (US)

Correspondence Address: MORGAN LEWIS & BOCKIUS LLP, 1111 PENNSYLVANIA AVENUE NW, WASHINGTON, DC, 20004, US

(73) Assignee: Octagon Research Solutions, Inc.,

(21) Appl. No.: 12/318,143

(22) Filed: Dec. 22, 2008

Related U.S. Application Data
(63) Continuation of application No. 10/430,091, filed on May 6, 2003, now abandoned.

(51) Int. Cl. G06Q 10/00; G06Q 50/00; G06F 3/048

(52) U.S. Cl. 705/9; 705/301; 705/342; 715/810

(57) ABSTRACT

Management of the processes involved with document publishing involves identifying tasks associated with the processing of information that is to form the publication and assigning worker resources to such tasks. Time to complete the tasks are estimated and schedules are developed. Actual work time is measured. Reports are generated and a planning tool is provided.

### BACKGROUND

Document publishing projects, such as those involved with the production of new drug/biological product marketing authorization applications (such as Investigational New Drug documentation (“IND”) and New Drug Applications (“NDA”)) for submission to the Food and Drug Administration (“FDA”) or corresponding regulatory bodies in, for example, Europe and Japan, are time consuming and labor intensive. These projects typically involve organizing and processing enormous amounts of documents and data. Such documents and data require specialized handling, as they are typically received in both paper and electronic form, and are in various file formats. In addition, given the large size of these projects, many worker resources are required over long periods of time are necessary to complete them. Issues virtually always arise, either with respect to processing the documents themselves, or with respect to worker resources or timing of projects. For these and other reasons, managing the document publishing process presents many challenges.

### FIELD OF THE INVENTION

The present invention relates generally to methods for managing business processes relating to document publishing projects.

### SUMMARY OF THE INVENTION

The present invention is directed to a method for managing a document publishing project. Document publishing project information is received. Upon receipt of the information, a plurality of work flows based on the information is automatically identified. Each work flow comprises one or more tasks and each task is associated with a capability for completing the task. A worker resource who has the capability associated with the task is automatically identified for each task. A schedule for the project comprising a task sequence and a resource allocation is created.

Still further, the present invention is directed to a method for managing a business process relating to one or more document publishing projects. Document publishing project information is received. A plurality of tasks for processing the information is identified. An indicator for each task is stored in a storage medium. One or more worker resources are assigned to at least one of the tasks. This assignment comprises associating an indicator for each worker resource with the indicator for the assigned task and storing the association in the storage medium. A work start time, a work end time, and one or more work pause periods of the worker resource for the assigned task are recorded. The work start time is automatically indicated upon the worker resource commencing work for the assigned task and the work end time is automatically indicated upon the worker completing work for the assigned task. Upon the indication of the work start time, measurement of an elapsed time to complete task is automatically commenced. The elapsed time to complete task comprises a difference between the work start time and the work end time. An execution time to complete task is automatically calculated based on a sum of worked time periods between the one or more work pause periods. The elapsed time to complete task and the execution time to complete task for the assigned task are stored in the storage medium.

The present invention is further directed to a graphical user interface for use in connection with managing a document publishing project. The graphical user interface includes a submission display area that displays document publishing project information arranged in accordance with a hierarchical structure. The structure comprises a plurality of structure elements including at least one submission level each of which comprises one or more folders levels; the folder levels each comprise one or more content item levels. The graphical user interface also includes a content item display area that displays content items information associated with one of the structure elements selected in the submission display area. The content item display area allows an operator to view, for all content items in the structure element, task information associated with the project information.

The present invention is also directed to a method for managing a business process relating a document publishing project. Document publishing project information is received. The project information is arranged in accordance with a hierarchical structure. The structure comprises a plurality of structure elements including at least one submission level which comprises one or more folders levels; the folder levels each comprise one or more content item levels. At least one work flow, comprising one or more tasks, for the information associated with the structure elements is maintained in a storage medium. One or more of the tasks are identified based on the information. One or more worker resources are assigned to at least one of the tasks.

The present invention is further directed to a method for managing a document publishing project. Document publishing project information is received. Based on the information, a plurality of work flows is identified, each work flow comprising one or more tasks. The tasks are assigned to one or more worker resources. Upon the worker resource identifying a processing issue with respect to the information, an indication of the processing issue associated with the information is automatically received. Based on the processing issue, an issue processing work flow is automatically identified. At least a portion of the identified issue processing work flow is assigned to one of the worker resources. A report comprising issue processing resolution information is generated.

The present invention is still further directed to a method for managing a plurality of document publishing projects, where each project comprises a plurality of tasks. Required worker resources and an estimated time frame to complete the tasks for each project are assigned. A first report comprising a total of required worker resources and a total estimated time frame to complete all tasks for at least two of the projects is generated. At least one of the required worker resources and the estimated time frame is changed. An impact on the ability to complete the projects resulting from the change is determined. A second report is generated reflecting the impact.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1A illustrates an exemplary system for carrying out a preferred embodiment of the methods of the present invention.

FIGS. 1B through 1E illustrate tables from an exemplary data model.

FIGS. 2 through 5 illustrate exemplary user interfaces that may be used in connection with a preferred embodiment of the present invention.

FIGS. 6 through 10 and 11A, 11B, and 11C illustrate exemplary reports that may be generated in accordance with a preferred embodiment of the present invention.

FIGS. 12 through 16 are flow charts illustrating preferred embodiments of the methods of the present invention.

### DESCRIPTION OF PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

The present invention provides a flexible method for managing projects relating to the production of large publications. The invention is particularly well-suited for managing the production of new drug/biological product marketing authorization applications (such as INDs and NDAs). However, the inventive system and method are equally suitable for managing the process of producing any high content volume publication. The inventive system and method can be used in connection with a project involving a single publication, or a portion thereof, or multiple publications. Publications (also referred to as submissions if submitted to, e.g., a regulatory authority for review), such as NDAs or INDs, typically are comprised of various types of content items that are arranged in accordance with a defined, hierarchical structure. For NDAs and INDs, this structure is specified by the agency that will review the application (i.e., in the United States, the FDA). Currently, publications of this sort are preferably submitted electronically, rather than in paper form given the extremely large volume of paper involved. The present invention can be used in connection with both paper and electronic submissions.

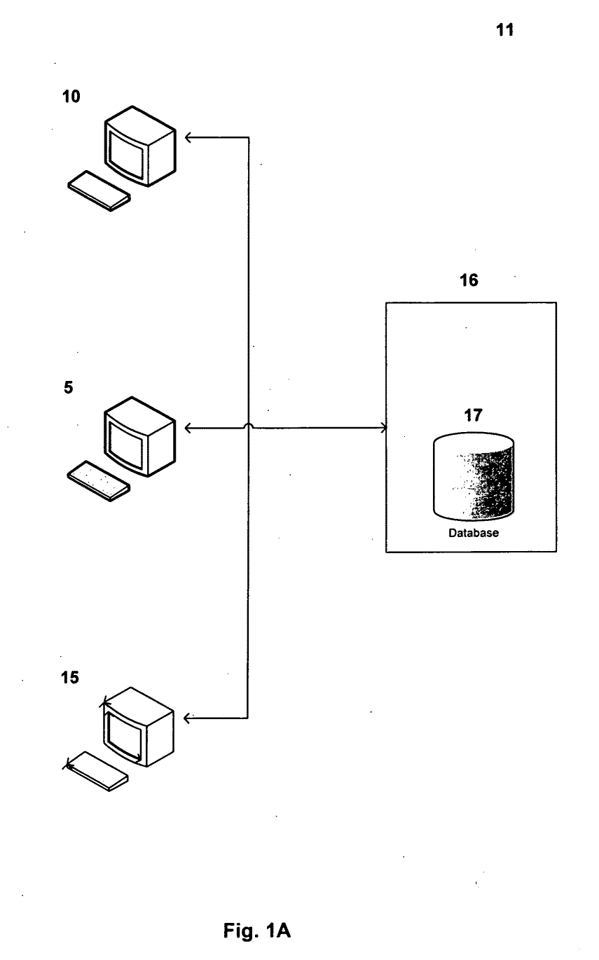

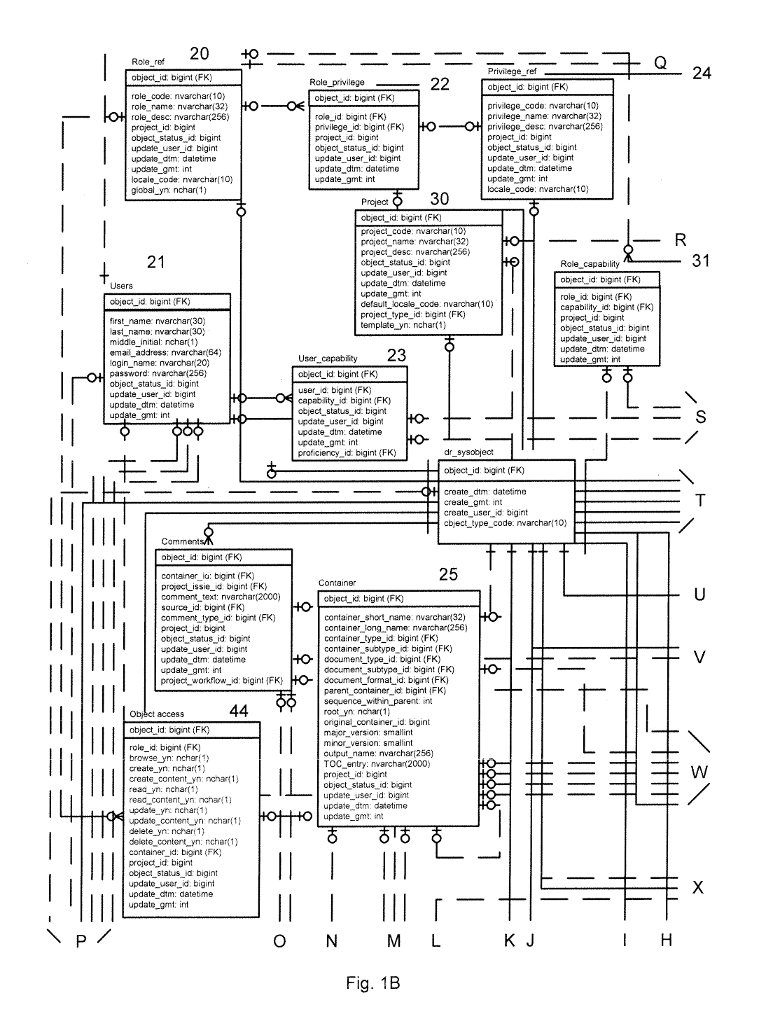

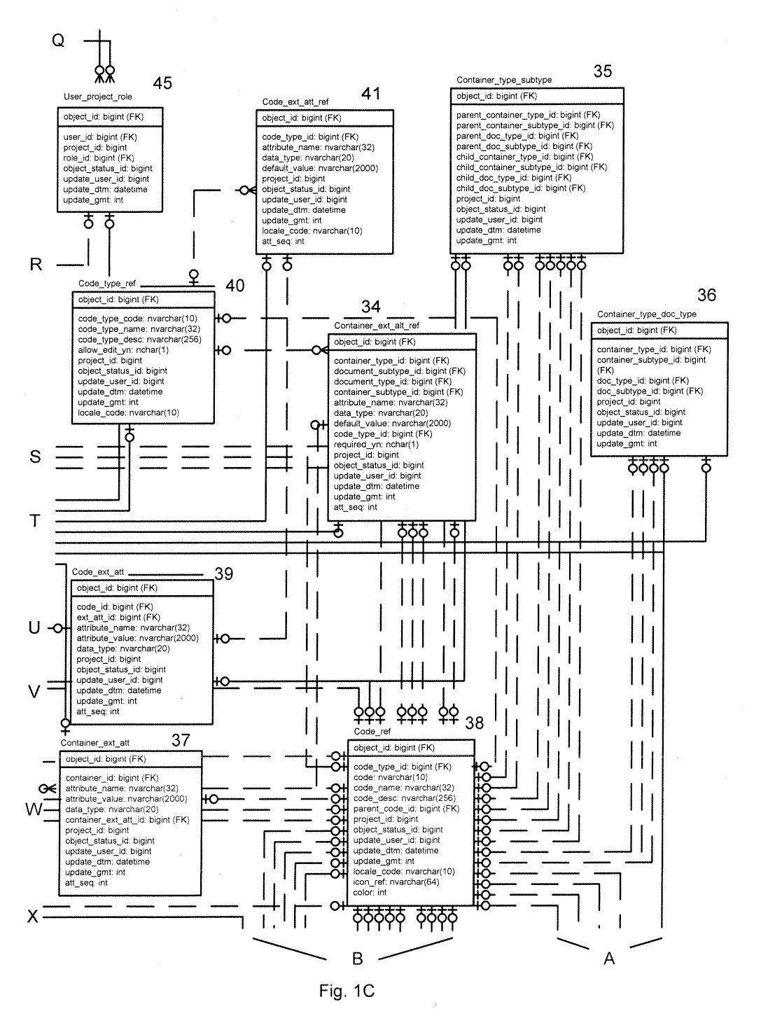

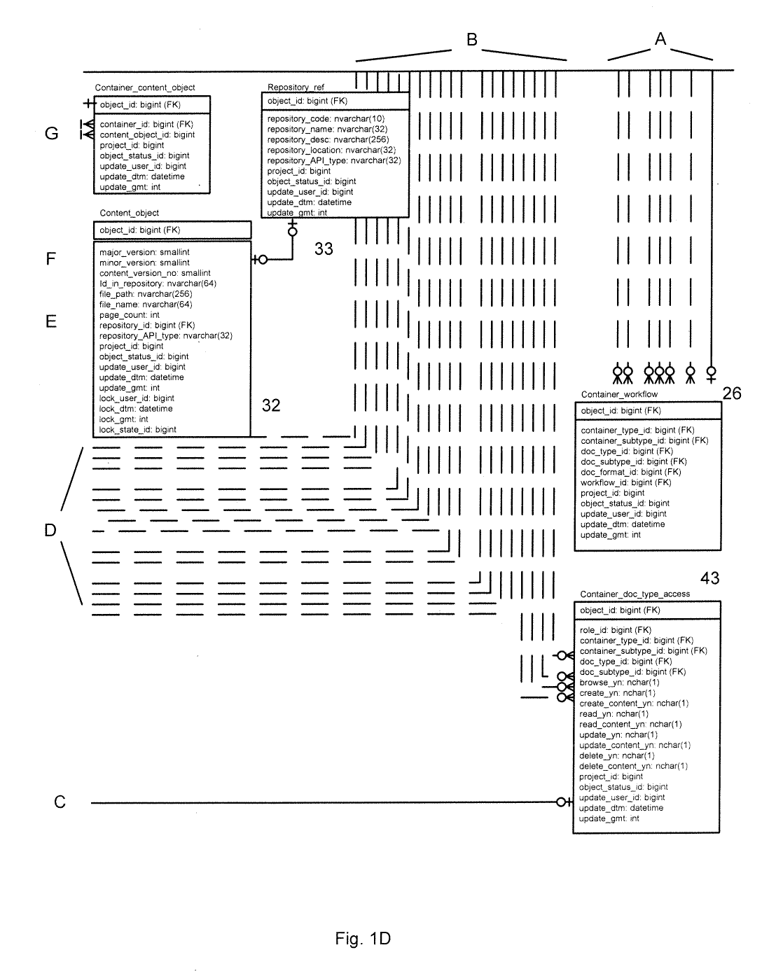

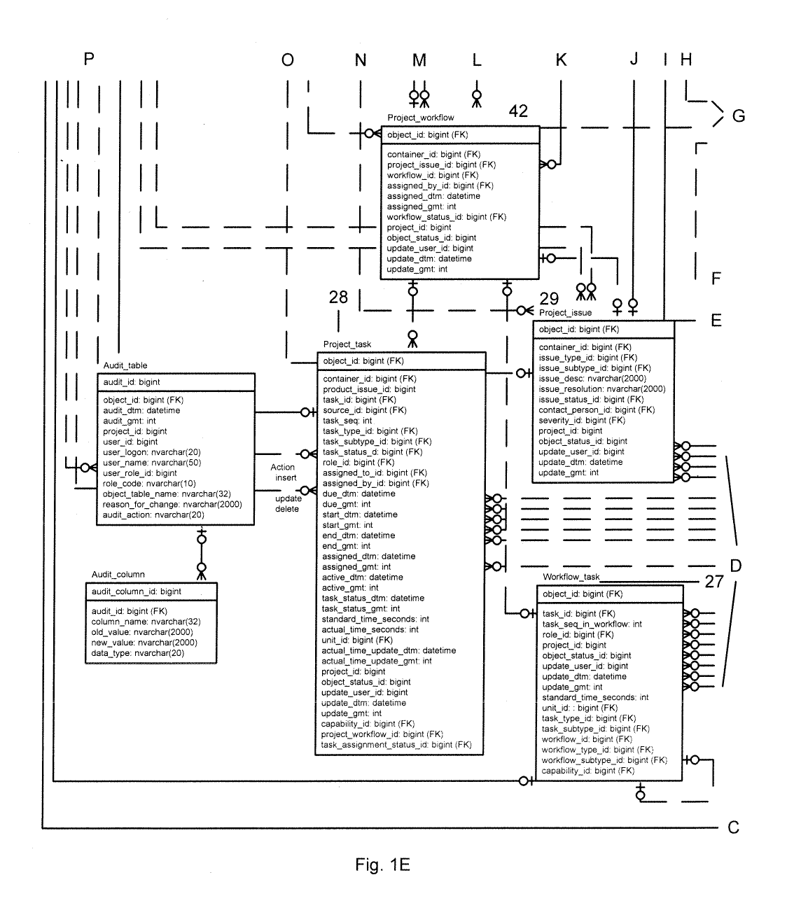

With reference to FIG. 1A, a system for implementing the present invention is illustrated. The document publishing process may involve a number of actors, each with different roles in the process. For example, upon the receipt of information relating to a document publishing project, a first actor(s) using client 10 may identify the information, determine what steps are required for processing the information, and work to implement schedules for completing the processing. Next, a number of second actors (e.g., worker resources), each using a client 5, are involved with the actual processing of the information. Finally, a third actor(s), using client 15, manages and plans multiple document publishing projects. Each of clients 5, 10, and 15 are networked to server 16, which includes a processor as well as one or more databases 17 for storing data used in connection with implementing the inventive methods. An exemplary data model for database(s) 17 is illustrated in FIGS. 1B through 1E and is described in more detail at various points within this detailed description of the invention.

Managing a document publishing project in accordance with the present invention begins upon the receipt of information relating to the publication. The received information may be in electronic form or paper form and comprises content items, such text files, graphs, tables, charts and data. For NDAs, the content items may include, by way of example, clinical study reports, statistical analyses, and text files. Content items received in electronic form are typically received in multiple formats, such as portable document format (e.g., .pdf files), word processing format (e.g., Microsoft Word files) or in tagged information file format (e.g., .tiff files).

If the information received relates to a new project, a template is selected. The template defines the structure for organizing the information that will ultimately form the publication. As discussed previously, for new drug/biological product marketing authorization applications, the structure is defined by the agency to which the publication will be submitted (e.g., the FDA). The template also provides work flows and associated business logic that specifies which work flows are required for which types of information. Upon establishing a structure using the template, the received information is then assigned to the appropriate location (i.e., structure element) within the structure (i.e., by assigning to the structure a pointer to the information which is contained within an accessible file storage system or document management system). If the information received relates to an existing project (i.e., a project for which a structure has previously been established), the received information is assigned (again, by inserting a pointer) to the appropriate location within the structure.

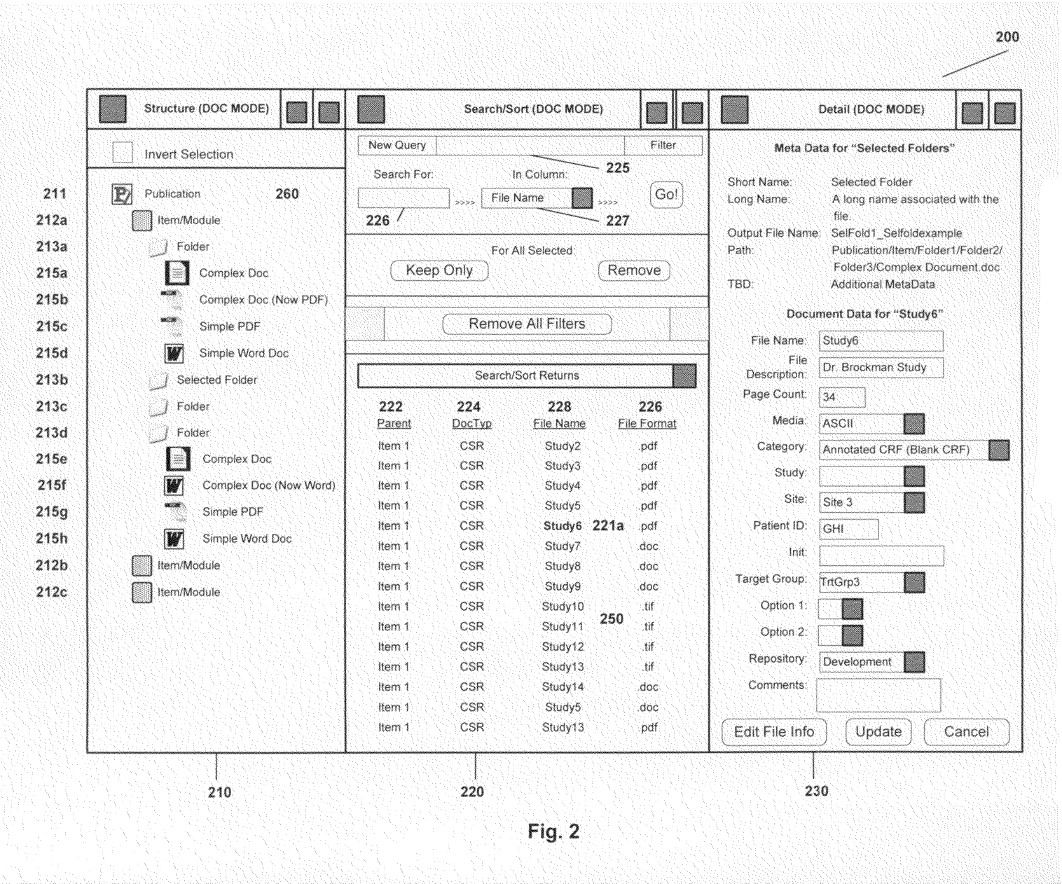

FIG. 2 illustrates an exemplary graphical user interface (“GUI”) for displaying information about an existing project (e.g., one or more submissions), which GUI may be viewed on client 10 of FIG. 1A used in connection with the present invention. The structure for this exemplary project is illustrated in panel 210. As shown in panel 210, information has been assigned to the structure. The highest level of the structure is typically the publication 211. In this example, the publication 211 includes one or more item/modules 212a, 212b, 212c; which include one or more folders 213a, 213b, 213c, 213d; which include one or more documents 215a, 215b, 215c, 215d, 215e, 215f, 215g, 215h. Documents may include complex documents (e.g., multiple content items concatenated to form a single complex document) or simple documents (e.g., a single PDF or Word document). Thus, a publication, such as an NDA, is represented in panel 210 by publication 211 and the contents of the publication are represented by item/modules 212a, 212b, 212c; folders 213a, 213b, 213c, 213d; and documents 215a, 215b, 215c, 215d, 215e, 215f, 215g, 215h.

FIG. 2 further illustrates a content item display area indicated by search/sort panel 220. Search/sort panel 220 displays all content items meeting a specific criteria that are contained within the particular structure element selected in structure panel 210. For example, in the embodiment illustrated in FIG. 2, upon a user selecting folder 213b, search/sort panel 220 displays the content items within folder 213b. Because no query has been indicated in dialog box 225, all content items within folder 213b are shown. If a query were entered in dialog box 225, assuming again that folder 213b is selected in structure panel 210, upon the operation of the query, only those content items contained within folder 213b that meet the query criteria would be displayed in search/sort panel 220.

Referring still to FIG. 2, search/sort panel 220 displays both characteristics of each particular content item and its relationship to other structure elements within the structure. Thus, in search/sort frame 250, parent 222 identifies the parent of which each particular content item is a child; doctyp 224 identifies the type of content item (e.g., a clinical study report); file name 228 identifies the file name associated with the content item; and file format 226 identifies the format of the content item as it is received (e.g., .pdf, .tiff).

Meta data for a structure element selected in structure panel 210 is displayed in detail panel 230 (in this example, Selected Folder, identified as folder 213b). The meta data associated with folder 213b includes the long and short name associated with the folder, the name of the output file, and the path (i.e., the pointer assigned to the structure indicating the location of the structure element itself in an accessible file storage system or DMS). Meta data regarding a content item selected in search/sort frame 250 is also displayed in detail panel 230 (in this example, Study 6, identified as file 221a). Meta data for file 221a shown in detail panel 230 includes the file description, page count, media, category, study, site, patient ID, target group and comments. In one embodiment, the meta data attributable to file 221a or folder 213b may be edited and updated using detail panel 230.

Virtually all received items of information that are to form part of the publication require some sort of processing. Such processing may include, for paper documents that are to form part of an electronic submission, scanning the paper document. The publication itself may also require processing, such as creating a table of contents and inserting hyper-links between documents within the publication. The present invention provides methods for managing the time and resources necessary to complete these activities.

In particular, upon receipt of information and assignment of the information to the structure, a work flow for processing the information (i.e., whether on a document, folder, item/module or publication level) is identified. In the preferred embodiment, the work flow is automatically identified based on the type of the structure element. Thus, for example, where the structure element is a document, the work flow is assigned based on whether the document is received in paper or electronic form and, if in electronic form, whether the document is in, e.g., .doc, .pdf, or .tiff format. Where the structure element is a folder or item/module comprising one or more documents, each individual document within the folder or item/module is identified and a work flow is automatically identified for each document. In other embodiments, the work flow is identified manually, in whole or in part. Each work flow comprises one or more tasks, which are performed in a specified sequence, in the preferred embodiment of the invention.

For example, the tasks associated with a work flow for a paper document may include scanning the document; correcting and enhancing the scanned image; transforming the file comprising the scanned image into a .pdf file; performing quality assurance on the .pdf file; performing regulatory quality assurance; bookmarking and hyperlinking the .pdf file in relation to other content items in the publication, and performing quality assurance of the same; performing a final quality assurance check; concatenating .pdf files to form complex documents; and returning the processed document to the entity that supplied the information in the first instance.

By way of further example, the tasks associated with a work flow for a .tiff file may include indexing the document; receiving the document; reviewing and inspecting the document; performing regulatory quality assurance; enhancing the document image and performing quality assurance of the same; transforming the .tiff to .pdf; bookmarking and hyperlinking the .pdf file in relation to other content items in the publication, and performing quality assurance of the same; performing a final quality assurance check; concatenating .pdf files to form complex documents; and returning the processed document to the entity originally supplying the information.

In another example, the tasks associated with the work flow for a .doc file may include indexing the document; receiving the document; reviewing and inspecting the document; performing regulatory quality assurance; transforming the .doc to .pdf; bookmarking and hyperlinking the .pdf file in relation to other content items in the publication, and performing quality assurance of the same; performing a final quality assurance check; concatenating .pdf files to form complex documents; and returning the processed document to the entity originally supplying the information.

In still another example, the tasks associated with a work flow for a .pdf file may include indexing the document; receiving the document; reviewing and inspecting the document; performing regulatory quality assurance; enhancing the document image and performing quality assurance of the same; bookmarking and hyperlinking the .pdf file in relation to other content items in the publication, and performing quality assurance of the same; performing a final quality assurance check; concatenating .pdf files to form complex documents; and returning the processed document to the entity originally supplying the information.

Once the tasks associated with a work flow for a structure element are identified, worker resources are assigned to complete the tasks. This is accomplished based on the capabilities required to complete each task. In particular, a worker resource who has the capability to perform the activities associated with a particular task may be assigned to the task. For example, a worker resource who has scanning capabilities will be assigned to tasks that require scanning (e.g., for processing information received in paper form). In addition to assigning tasks based on capabilities, task are also assigned, in the preferred embodiment, based on the estimated time to complete the task and the work load of the worker resource given other tasks assigned to the worker resource in connection with the current project or other projects. In most instances, tasks for a given work flow are arranged sequentially, meaning that one task cannot be commenced until its predecessor task has been completed.

Upon consideration of the factors associated with task assignment, tasks are automatically assigned to worker resources. In some embodiments, the automatic assignment may be manually overridden to account for, e.g., vacation schedules or other factors not known or accounted for by the automated system.

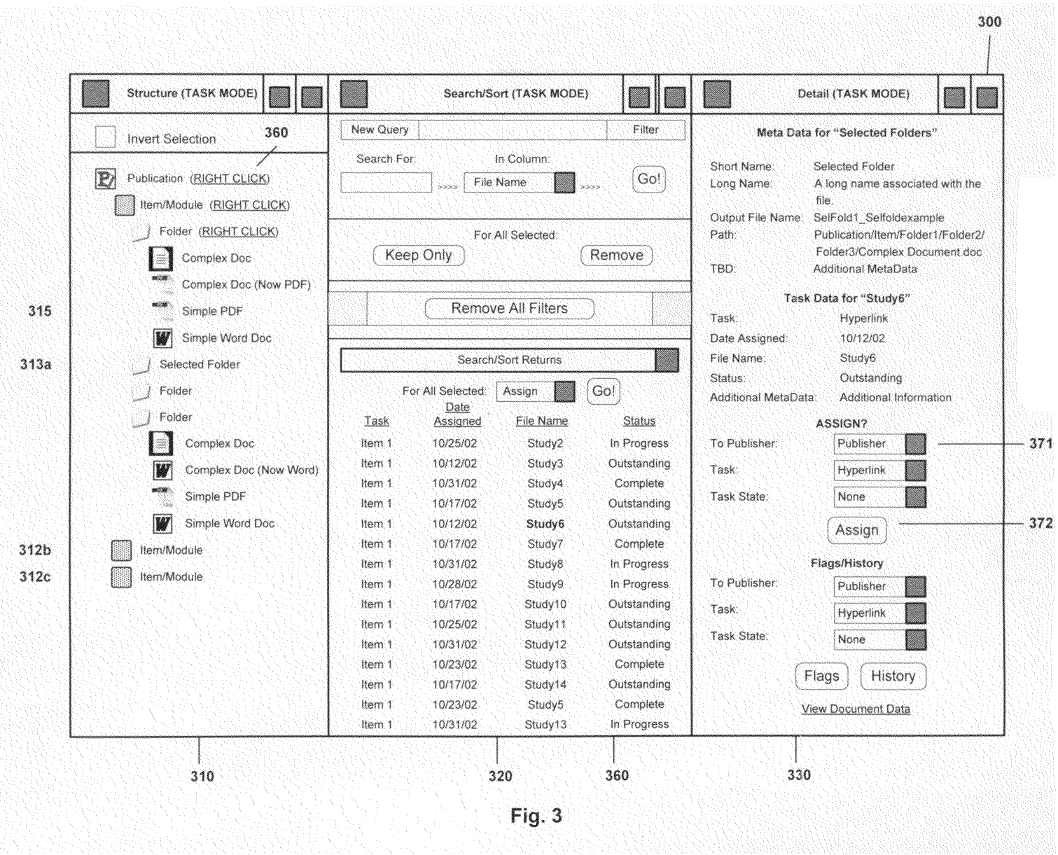

With reference to FIG. 3, task mode GUI 300 provides an overview of tasks assigned for a particular project. As with FIG. 2, search/sort panel 320 and detail panel 330 present progressively more detailed information corresponding to the structure elements selected in structure panel 310 and search/sort panel 320. Thus, detail panel 330 display details on the task selected in search/sort panel 320 (e.g., Study 6) and search/sort panel 320 provides additional, task-related detail for the items selected in structure panel 310. In a preferred embodiment, detailed task information associated with a particular project may be viewed in search/sort panel 320 for all content items associated with the structure element selected in structure panel 310 (e.g., publications, item/modules, folders).

In the embodiment shown, folder 313a has been selected in structure panel 310. As shown in search/sort panel 320, folder 313a contains multiple files (file name 326) each having a task 322, the date the task was assigned 324, and the status of the task 328. A query may be made against the task list to identify in search/sort panel 320 only those tasks meeting the criteria of the query. Detail panel 330 provides details regarding the task selected in search/sort panel 320. For example, for the selected Study 6, the associated task is hyperlinking, which was identified for the content item on Oct. 12, 2002, and the task is outstanding (meaning that it has not yet been assigned to a particular worker resource). Publisher box 371 provides the name of a worker resource assigned to the task. This worker resource has the capabilities required to perform the task, as well as the time to complete the task given the worker resource's current work load. In some embodiments, the worker resource is automatically assigned to the task. However, in other embodiment, a suggestion as to a worker resource to assign to the task is made and the worker resource is actually assigned to the task manually.

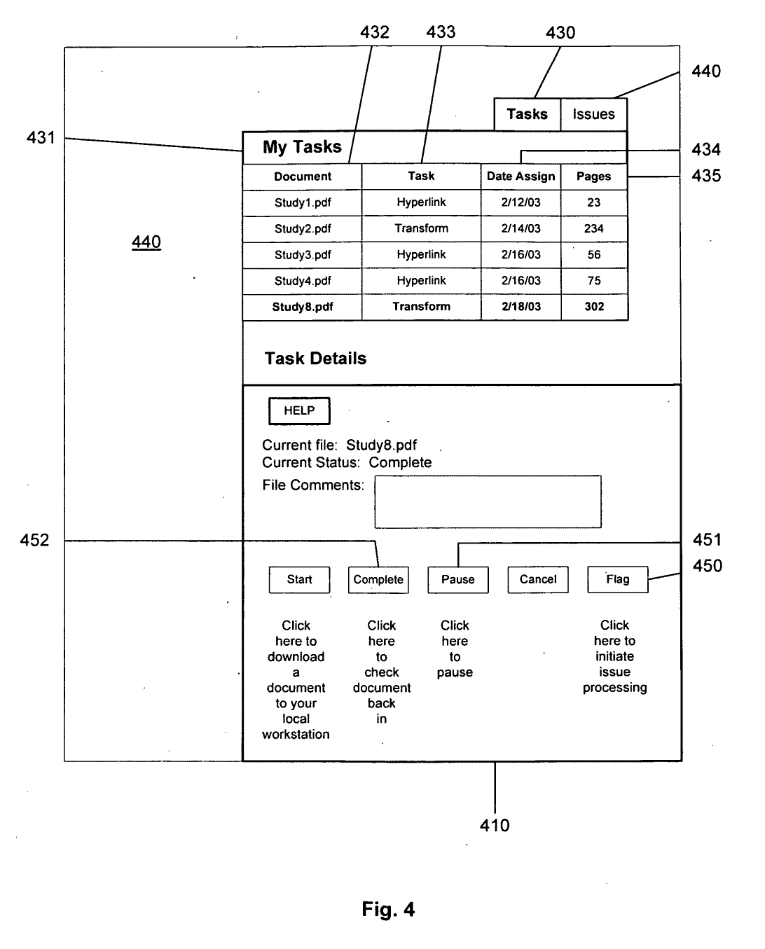

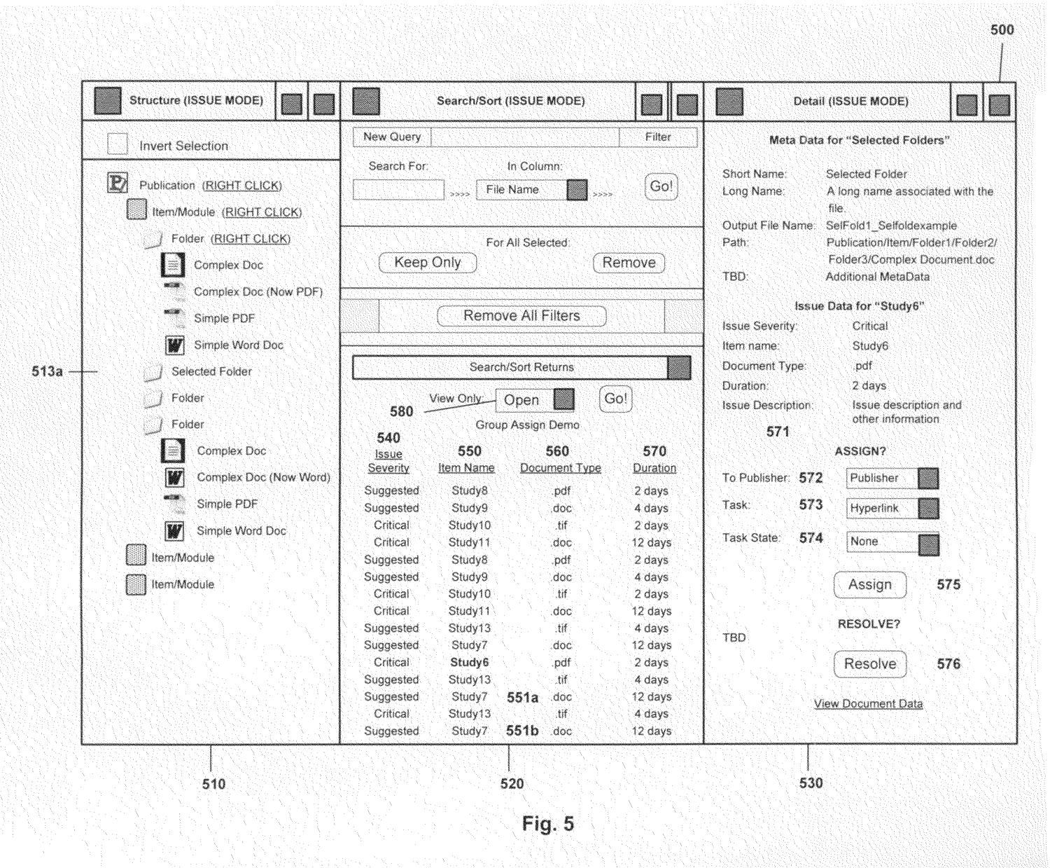

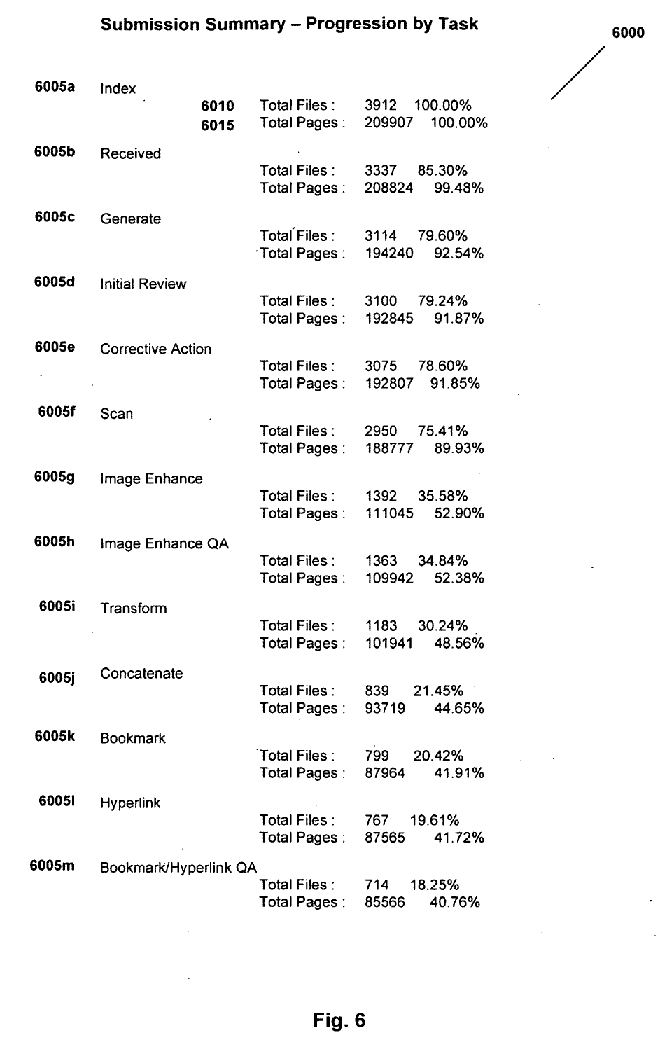

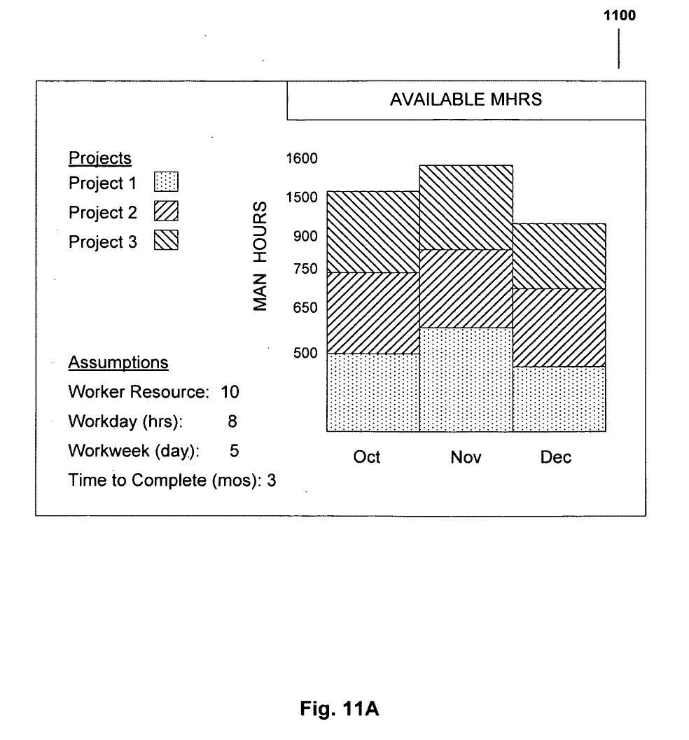

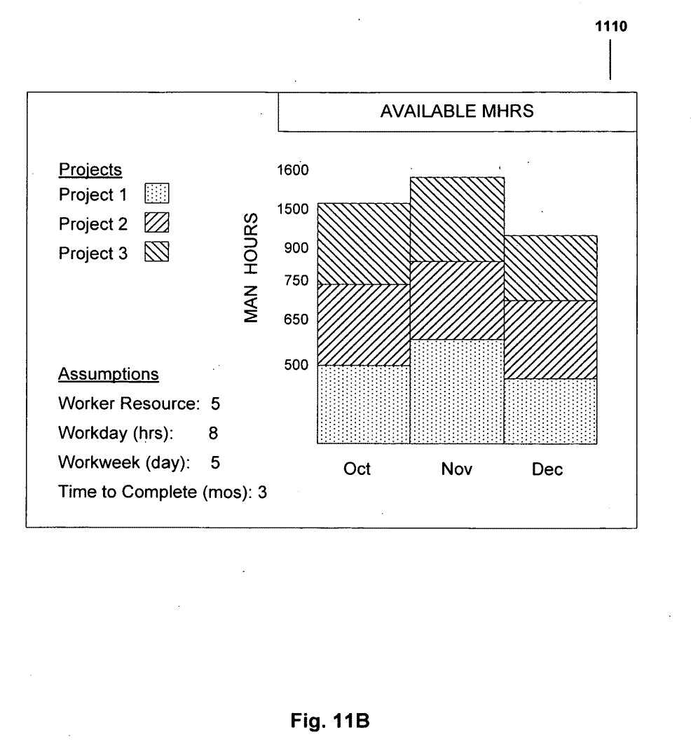

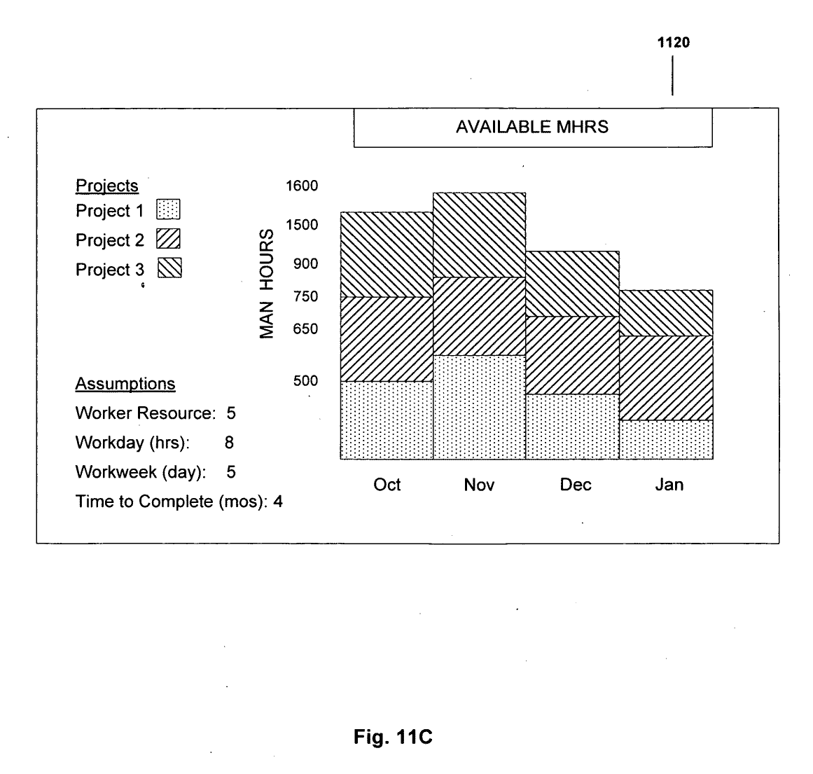

For each project, a schedule is maintained regarding each task that has been and must be completed for the project; the worker resources assigned to each task; and the estimated amount of time required to complete each task. The schedule is used to, for example, assign workers to new projects and associated tasks, prepare project reports as discussed with regard to FIGS. 6 through 10, and conduct planning activities, as discussed in more detail with reference to FIGS. 11A, 11B and 11C. In the preferred embodiment, the schedule is updated to reflect newly received projects and project information, worker resources allocations, newly added or lost worker resources, processing issues (discussed in more detail with reference to FIGS. 4 and 5), and completion of tasks.

Worker resources that are assigned tasks are able to manage their tasks using, in one embodiment, a GUI 400 such as that shown in FIG. 4. GUI 400 includes panel 410 which enables the worker resource to view a list of tasks assigned to the worker resource by selecting tasks tab 430. The worker resource may view a list of issues assigned to the worker resource by selecting issues tab 440. A more detailed discussion relating to the identification of processing issues, and assignment of tasks relating thereto, is provided with reference to FIG. 5. Upon selecting the tasks tab 430, the worker resource will view the my tasks screen 431. Similarly, selection of the issues tab 440 results in the presentation of the my issues screen (not illustrated but may look like screen 431). My tasks screen 431 presents information such as the identity of the document 432 with which the task is associated, the specific task 433 assigned, the date 434 that the task was assigned, and, if relevant, the number of pages 435 in the document 432.

Upon the worker resource commencing work on an assigned task, the work start time for the project is recorded. In the preferred embodiment, the work start time is recorded automatically upon the worker resource downloading the document 432 to his/her local work station (e.g., client 5 of FIG. 1A). The worker resource then sets upon completing the particular task. If the worker resource takes a break from working on the task (e.g., for lunch or at the end of the day), the worker resource indicates the same by, e.g., clicking on pause button 451. When the worker resource completes the task, the worker resource clicks on complete button 452. In another embodiment, when the worker resource completes the task, the document 432 that is the subject of the task is checked back in. In either case, upon the worker resource completing the task, a work end time is recorded.

Based on the work start time, the work end time and any pause periods, an elapsed time to complete task (i.e., the total amount of time elapsed between the commencement and the completion of the task) is measured and stored. Further, an execution time to complete task (i.e., the sum of all worked time periods for the task) is calculated and stored.

During the processing of a structure element in accordance with an assigned task, a worker resource may encounter a processing issue with respect to the structure element. For example, the worker resource may find that a file contained on a disc is corrupt. For a paper document, the worker resource may find that the paper is torn, and unable to be scanned easily, or that the print on the paper is unclear. Numerous other processing issues are possible. Upon the processing issue presenting itself, the worker resource indicates the existence of the processing issue. Referring to FIG. 4, this can be achieved by the worker resource clicking on flag button 450. Upon the worker resource clicking on flag button 450, the fact of the processing issue is identified within the system and a work flow for resolving the processing issue is identified. The work flow for a processing issue might include identifying the issue; assigning the issue; resolving the issue; and implementing the resolution. Within the resolution step, corrective action is identified, in the preferred embodiment, by the original document generator from whom the document was received. Then, the necessary corrective action is taken by the worker resource in implementing the resolution.

Upon the tasks associated with the work flow for resolving the processing issues being assigned to the worker resources, the worker resources may review, and commence processing of, tasks assigned to them using the GUI associated with task issue tab 440 of FIG. 4.

Referring to FIG. 5, issues may be monitored for all projects in the issue mode of GUI 500. In issue mode, search/sort panel 520 provides an active list of all issues related to the structure element selected in structure panel 510 (corresponding to panel 210). As illustrated in FIG. 5, selected folder 513a contains a number of content items with associated issues (i.e., Study 8, Study 9, Study 10, etc.). For each content item, search/sort panel 520 identifies the severity of the issue 540 and the duration of the issue 570. Issue severity 540 may be rated as mild, moderate, or severe. Severity ratings may be represented numerically as well. For example, the integers 1, 2, or 3 in the preferred embodiment, represent severity ratings of mild, moderate and severe, respectively. If a content item has more than one issue, a separate entry for each issue is provided in search/sort panel 520 (e.g., such as Study 7).

In the embodiment shown, “Open” has been selected from drop down menu 580 indicating that only open issues are illustrated in search/sort panel 520. Open issues are issues that are not yet resolved. In the embodiment shown, issue severity 540 indicates the priority to be placed on resolving open issues associated with a particular content item. Duration 570 indicates how long an issue has been open or was open before being closed.

In issue mode, detail panel 530 presents details for the processing issue selected in search/sort panel 520. As illustrated in FIG. 5, the item 550 selected in search/sort panel 520 is Study 6 having an issue severity of critical and a duration of 2 days. Detail panel 530 provides a description of the issue in box 571, the worker resource to whom the processing issue is assigned for resolution in box 572 (e.g., Publisher); the description of the issue task in box 573 (e.g., Hyperlink); and the state of the issue task in box 574. Assign button 575 allows for the re-assignment of the issue task to the worker resource identified in box 572. Upon assignment of the issue task, the task will be presented to the worker resource in the issue panel 410 of FIG. 4. Resolve button 576 allows for indicating that a resolution of the issue has been devised and, thus, implementation of the resolution can now be commenced.

An exemplary data structure for implementing the features of the present invention is described with reference to FIGS. 1B through 1E.

With reference to FIG. 1B, meta data for each project is maintained in project table 20. Each actor taking part in the document publishing process for a project, including worker resources, is assigned a role. Roles dictate the privileges of each actor in terms of its use of and access to the inventive system. The tables used for implementing this feature are user table 21, role ref table 20, role privilege table 22, and privilege ref table 24. With reference to FIGS. 1B and 1D, container doc type access table 43 and object access table 44 contain security access information based on roles. User project role table 45 maintains information regarding each user's role for a given project (i.e., a user may have different roles for each project).

Each role is associated with one or more capabilities, as indicated in role capability table 21. Each actor is assigned one or more capabilities, as discussed in more detail in the following. The capabilities concept applies predominantly to worker resources and reflects the worker resources' skills in performing certain tasks. User table 21 and user capability table 23 are used to implement this feature.

With reference to FIG. 1B, container table 25 maintains information relating to each structure element (identified using the object identifier) within a structure for a publication (i.e., publication, folder, item/module, document). Each container item is associated with a container type id, container subtype id, document type id, document subtype id, and document format id. The hierarchy among content items/container types is maintained in container table 25 (i.e., using the fields parent container id and sequence within parent). With reference to FIG. 1C, more specific information regarding these five types of identifiers is maintained in container ext att table 37, container ext att ref table 34, container type subtype table 35 and container type doc type 36.

Codes are used to drive the inventive system. In particular, structure elements, work flows and task are all assigned codes. The logic of the inventive system is based on how the codes relate to one another. With reference to FIG. 1D, code reference table 38, code ext att table 39, code type reference table 40, and code ext att reference table 41 maintain information about such codes.

With reference to FIG. 1C, content object table 32 provides meta data regarding the structure elements themselves the are to form the publication. For example, the container to which the structure element belongs is identified, along with information regarding the location of the structure element (file path, file name) within an accessible storage system (repository id). Repository ref table 33 maintains more specific information regarding the repository, with reference to FIG. 1D.

Based on at least some of the five identifiers (i.e., container type id, container subtype id, document type id, document subtype id, and document format id), a work flow for each structure element is obtained from container workflow table 26, with reference to FIG. 1D. In some instances, not all of these five identifiers are available for a particular structure element. If more identifiers are available, the work flow identified will be more specific. For example, a very generic work flow may be identified if only a container type is known (e.g., if the container type is a publication). However, a more specific work flow-may be identified if the container type, document type and document format are known (e.g., if the container type is a single document in a known format). Upon identifying the workflow for a particular structure element using table 26, workflow task table 27 (FIG. 1E) is consulted to determine the tasks associated with the work flow. The identified tasks for the particular content item are then copied to project task table 28.

Project work flow table 42 maintains certain global information about the work flow. For example, this table maintains all the work flow information, and all the tasks relating thereto, for a project, in addition to, for example, the start time and end time for the entire set of work flows.

Once tasks are identified and copied to project task table 28 (FIG. 1E), tasks are assigned to worker resources. This is accomplished based on the capabilities required for each task, the capabilities of the worker resources, and the work loads of the worker resources. Referring to workflow task table 27, each task includes a capability (identified using the capability id). Consulting the user capability table 23, the identity of each worker resource (identified by the user id) that has the required capability is determined. Then, a work load for each of the identified worker resources is determined. This is accomplished by consulting project task table 28 (assigned to id) to identify all of the tasks assigned to each worker resource and by determining the amount of time required to complete each task. The estimated time to complete each task (standard time minutes) is known from project task table 28 (obtained originally from workflow task table 27).

Assigning tasks to worker resources can be done automatically or manually. Project task table 28 (and, in particular, assigned by id) reflects whether automatic or manual assignment was done.

Project task table 28 also reflects the due date and time for an assignment (due dtm). The due date is calculated based on the sequence of the particular task within the workflow and the estimated time for completing each task. For example, if a particular task is the third in a work flow, the estimated time for completing the first two tasks must first be determined. The order in which the tasks must take place (task seq in workflow) is known from workflow task table 27 and, again, the estimated time to complete task (standard time minutes) is known from project task table 28. Whether a particular task is active is reflected in project task table 28 (active dtm). The first task in a work flow becomes active and stays active until the document associated with the task is checked in. The next task in the work flow does not become active until the preceding task is completed.

When a worker resource is prepared to commence working on a task, the worker resource performs some activity that indicates the same (e.g., downloading the document associated with the task to the local work station or pressing an indication button). Upon doing so, the work start, time is indicated in the database (i.e., start dtm of project task table 28). Upon the worker resource concluding work on the task, again, some indication is made and reflected in the database (i.e., end dtm of project task table 28). When a pause period is indicated by the worker resource, time is not recorded for this period. The execution time (i.e., the total actual amount of time taken by the worker resource to complete the task, reflected as actual time minutes in project task table 28) is an accumulation of individual worked time periods.

Processing issues identified by worker resources are reflected in project issue table 29. Project issue table 29 includes information regarding the issue identifier, a description of the issue, the status of the issue (i.e., active or inactive), the individual to contact regarding the issue, the severity of the issue and the work flow associated with the issue. Work flows for processing issues are treated in the same manner as tasks and, thus, information relating to them is maintained in project task table 28.

In order to implement the planning features of present invention (illustrated with reference to FIGS. 11A, 11B, and 11C), the project task table 28 is first used to obtain the known parameters for a given set of projects (tasks, worker resources assigned thereto, and estimated time frames). Then, a temporary table is built on-the-fly that reflects changes to the parameters made by the project manager during the planning process.

Various types of reports may be generated in connection with the inventive method to assist in the project management process.

A report relating to the progress of each task associated with a submission may be generated. An example of such a progress report 600 is illustrated in FIG. 6. For each task 605a through 605m, the report provides the total number of files 610 and the total number of pages 615 within the submission (i.e., publication) that have been processed in accordance with the identified task 605a through 605m. For example, the indexing task 605a has 3912 total files and 209,907 total pages that have been processed (i.e., 100% for this submission). Similarly, 1183 of the files (i.e., 30.24%) and 101941 pages (i.e., 48.56%) in this submission have been transformed (task 605i).

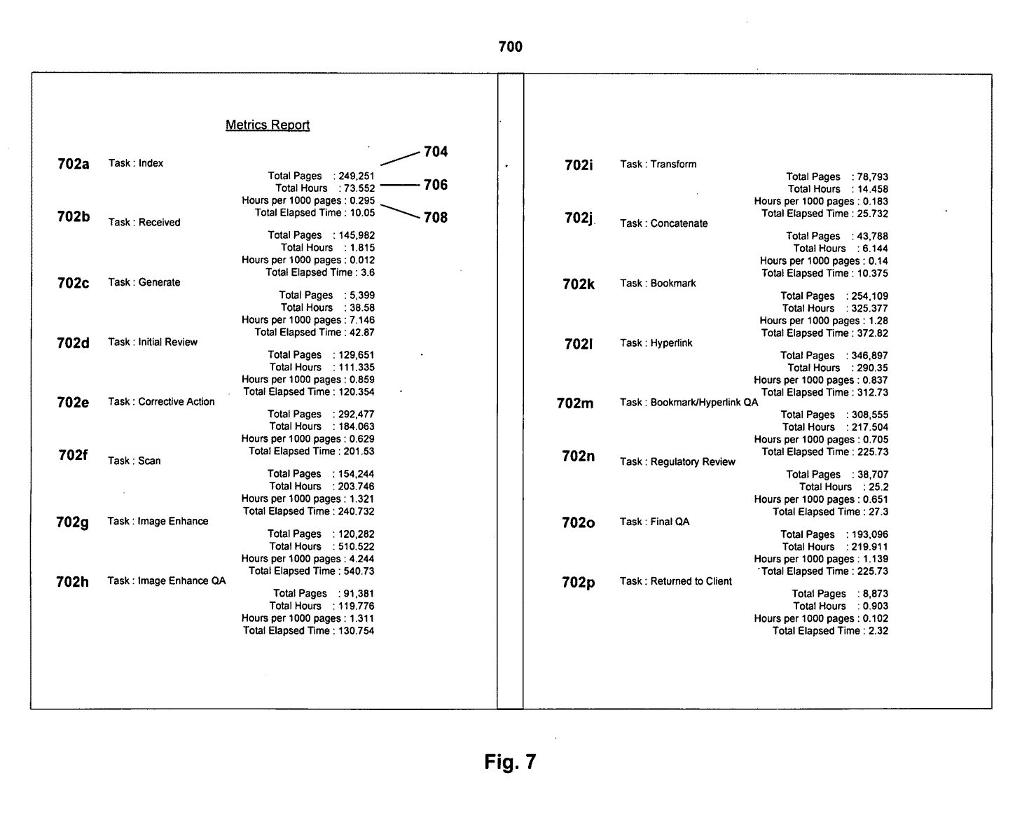

FIG. 7 illustrates an example of a metrics report 700. Metrics report 700 is a type of task level report which provides, for each task associated with a work flow for a structure element within a submission, a snap-shot of the progress made in completing each task 702a through 702p. For example, for task 702a, the total pages processed 704 is 249,251; the total hours 706 spent on task are 73.552 hours, and the corresponding rate of production 708 is 0.295 hours per 1000 pages processed.

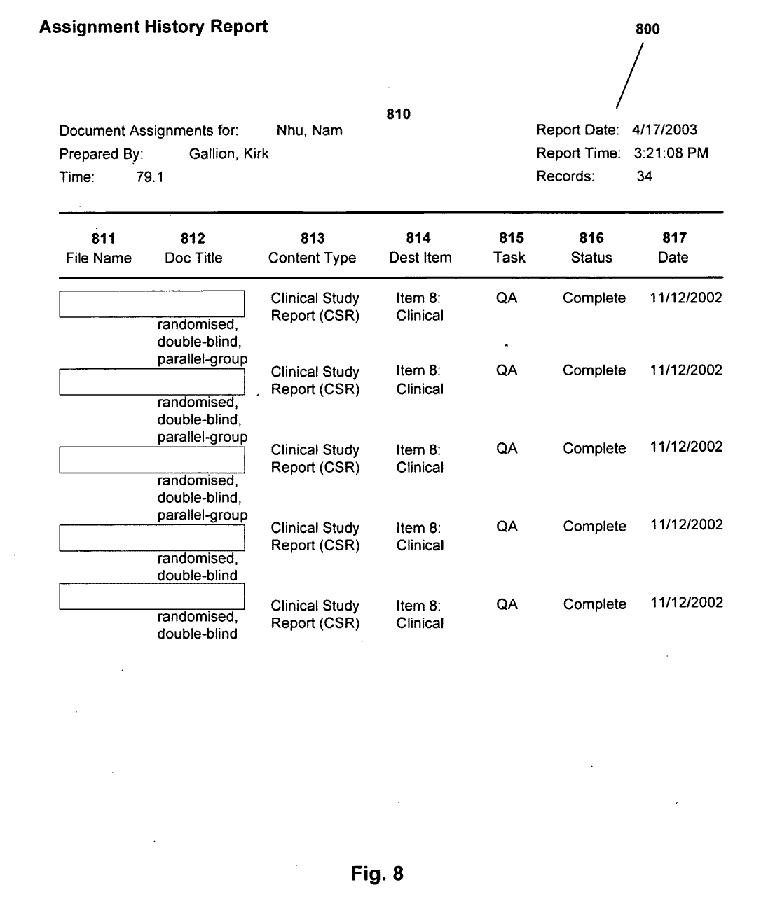

A report indicating assignment of worker resources for a project can be generated. With reference to FIG. 8, assignment history report 800 describes tasks 815 assigned to a particular worker resource 810. The document title 812 and file name 811 with which the task 815 is associated are provided, as well as the status 816 of the task and the date 817 of the status.

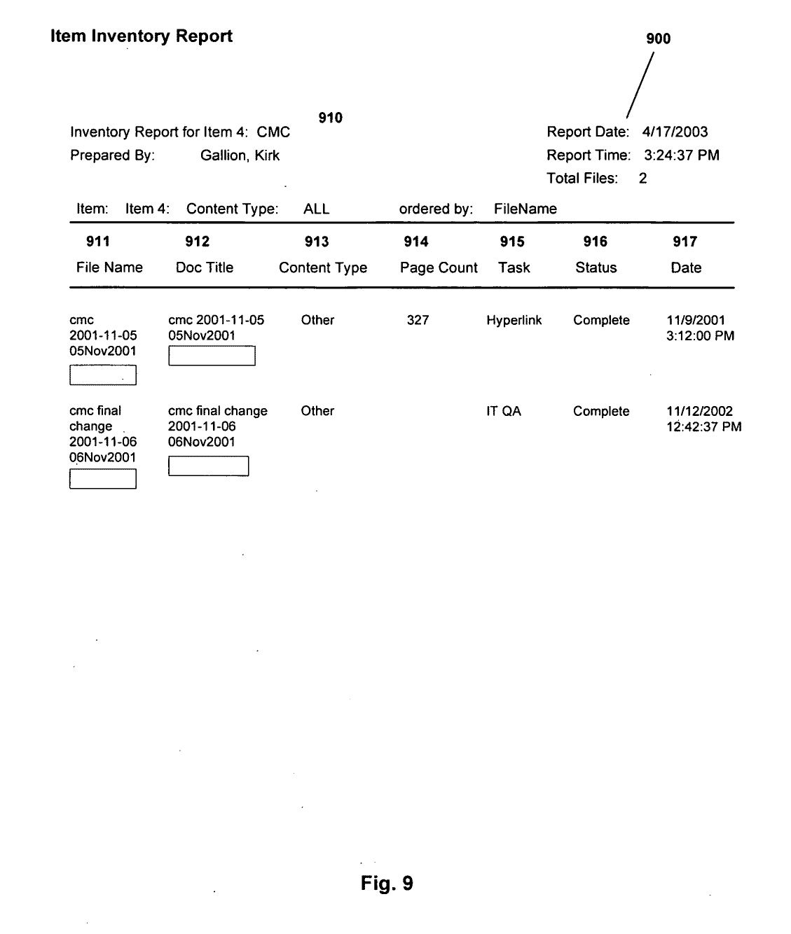

With reference to FIG. 9, item inventory report 900 provides information regarding tasks for structure elements associated with a particular project. Thus, for a structure element with title 912 and file name 911, the type 913 of content is identified, along with the page count 914, the task 915, the status 916 of the task and the date 917 of the status.

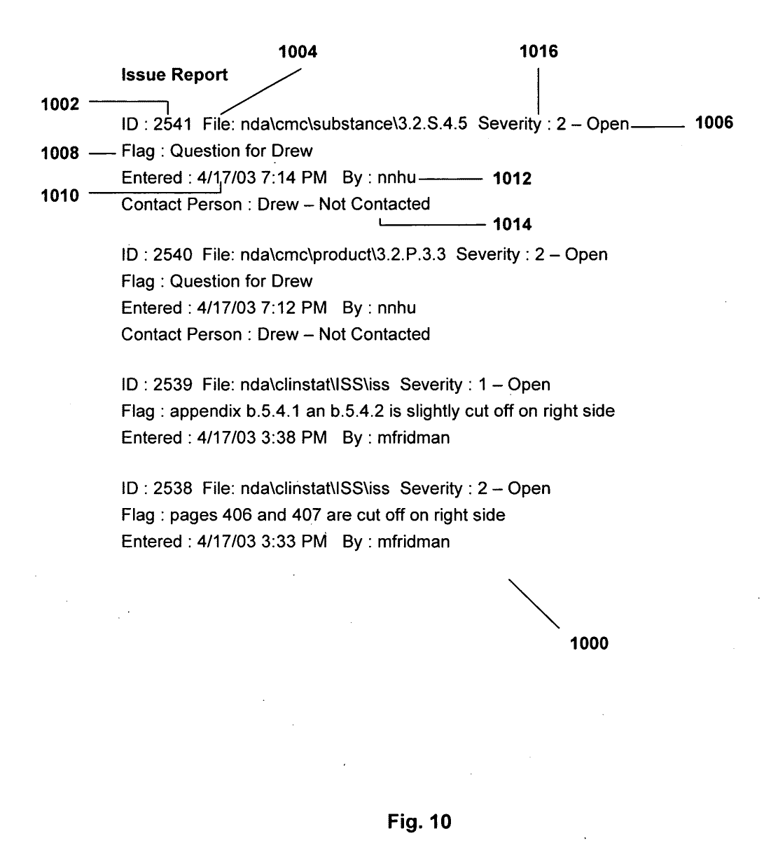

An example of an issue report is illustrated in FIG. 10. In issue report 1000, issue identifier 1002 is indicated, along with the file 1004 with which the issue is identified. The severity of the issue (e.g., 1-mild, 2-moderate or 3-severe) is presented in field 1016. The status of the issue (e.g., open, closed) is presented in field 1006. Further, a brief description of the issue 1008 is identified, along with the time the issue was entered and the identity of the individual entering the issue 1012. In addition, the person to contact 1014 for the issue may be provided.

The generating of scheduling information and gathering of metrics allows for managing multiple publication production projects and for planning for events that may impact the production schedule. For example, not only can reports be generated describing the time and resources required for implementing multiple projects at one time, a project manager can determine how project parameters (worker resources and time frames) will be impacted given a change in circumstances (e.g., gaining or losing one or more worker resources; receiving more project information than expected; project completion timelines being extended or shortened).

FIG. 11A illustrates an exemplary report 1100 that may be used in managing a number of publication projects, in this case, Project 1, Project 2 and Project 3. The scenario reported on in report 1100 assumes that 10 worker resources are available, who each work an 8 hour day, five days a week, to work on all of Projects 1, 2 and 3. Given the tasks associated with each project, and the estimated time to complete these tasks, report 1100 informs the project manager that a sufficient number of worker resources are available (i.e., available man hours) to complete all three projects by the end of December.

However, the project manager knows that his work force will be cut in half during the months of October, November and December. Thus, using the planning tool of the present invention, the project manager indicates a scenario in which he will have only 5 worker resources available to work on the three projects. Report 1110 of FIG. 11D is generated based on this set of facts and the project manager is informed that he will not have the available man hours to complete all three projects before the end of December. Thus, he develops a new scenario in which one additional month is taken to complete the projects. Report 1120 of FIG. 11C is generated and informs the project manager that he will have sufficient man hours to complete all three projects, using only five worker resources, over the course of four months.

Given that the number of tasks associated with any given project is, typically, constantly changing (i.e., because new information is received, issues arise etc.), reports such as report 1100 may be generated frequently to provide the project manager with up-to-date information required to manage the projects.

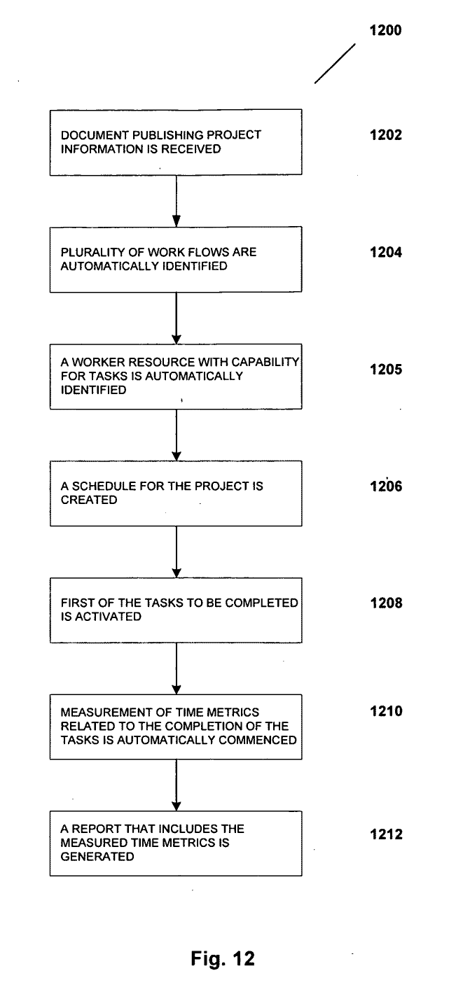

FIGS. 12 through 16 are flow charts illustrating methods in accordance with a preferred embodiment of the present invention.

Referring to FIG. 12, a method 1200 for managing a document publishing project is illustrated. In step 1202, document publishing project information is received. In step 1204, a plurality of work flows are automatically identified, based on the received information. Each work flow includes one or more tasks and each task is associated with a capability for completing the task. In step 1205, a worker resource who has the capability to complete the task is identified. In step 1206, a schedule for the project is created. In one embodiment, the method further includes, in step 1208, activating a first of the tasks to be completed. In step 1210, upon activating the first of the tasks, measurement of time metrics related to the completion of the tasks is automatically commenced. In step 1212, a report that includes the measured time metrics is generated.

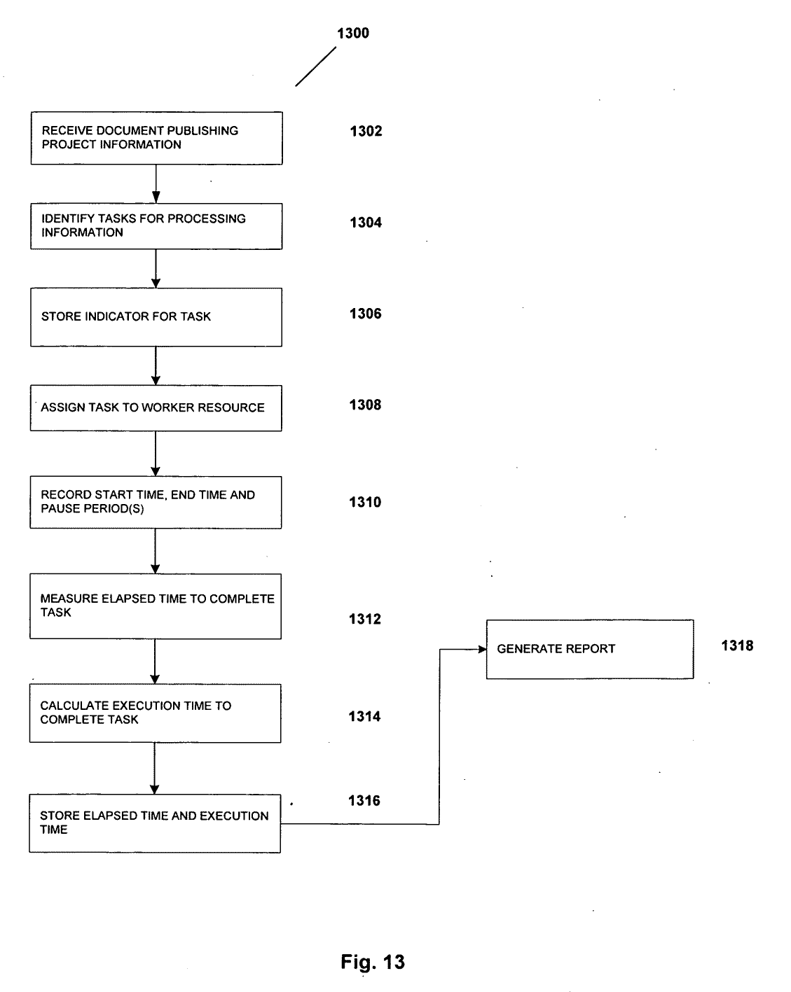

Referring to FIG. 13, a method 1300 for managing a business process relating to one or more document publishing projects is illustrated. In step 1302, document publishing project information is received. In step 1304, a plurality of tasks for processing the information is identified. In step 1306, for each task (e.g., a task identified in step 1304) an indicator is stored in a storage medium. In step 1308, at least one of the tasks assigned to one or more worker resources. In a preferred embodiment, the assignment of the task to the worker resource includes associating an indicator for each worker resource with an indicator for the assigned task (e.g., the indicator of step 1306) and storing the information in a storage medium.

In step 1310, a work start time (e.g., the time a worker resource begins work on a task) and a work end time (e.g., the time a task is completed) are recorded, and one or more work pause periods are indicated. The recorded information is associated with the worker resource assigned to the particular task. The work start time is automatically indicated upon the worker resource commencing work on the assigned task. The work end time is also automatically indicated upon the worker completing work on the assigned task.

In step 1312, the measurement of an elapsed time to complete task is automatically commenced. The elapsed time to complete task includes a difference between the work start time and the work end time. In step 1314, an execution time to complete a task is automatically calculated. The execution time is a sum of worked time periods between the one or more work pause periods. In step 1316, the elapsed time to complete a task and the execution time to complete a task are stored in the storage medium. In step 1318, a report relating to the projects is generated.

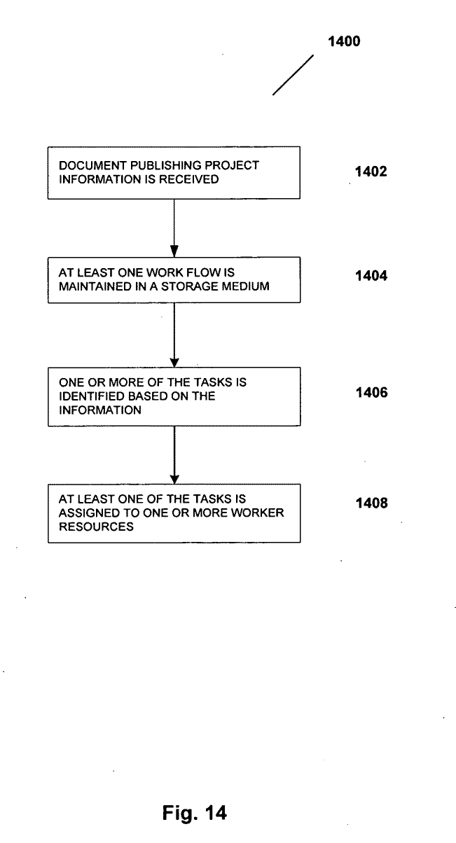

Referring to FIG. 14, a method 1400 for managing a business process relating an electronic document publishing project is illustrated. In step 1402, document publishing project information is received. The project information is arranged in accordance with a hierarchical structure. The structure includes a plurality of structure elements including at least one submission level, each of which comprises one or more folders levels, wherein the folder levels each comprise one or more content item levels. In step 1404, at least one work flow is maintained in a storage medium, which includes one or more tasks for the information associated with each of the structure elements. In step 1406, one or more of the tasks is identified based on the information. In step 1408, at least one of the tasks is assigned to one or more worker resources.

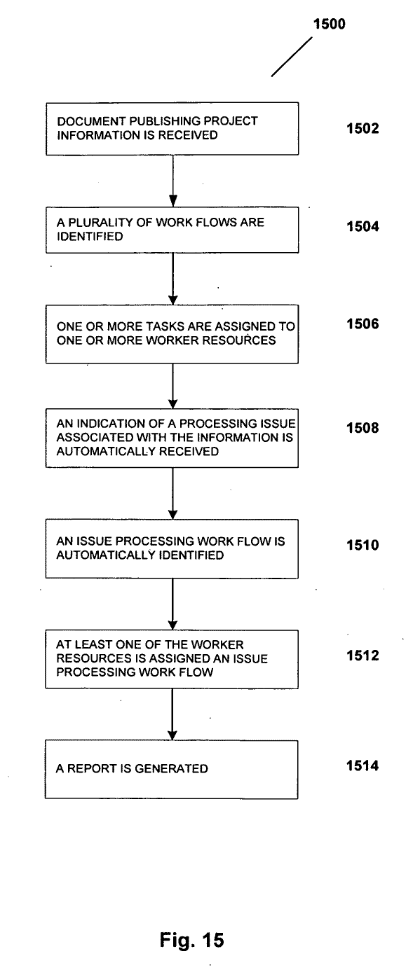

Referring to FIG. 15, a method 1500 for managing a document publishing project is illustrated. In step 1502, document publishing project information is received. In step 1504, a plurality of work flows are identified, based on the information received in step 1502, which work flows include one or more tasks. In step 1506, the tasks are assigned to one or more worker resources. Upon the worker resource identifying a processing issue relating to the project information that is the subject of the task, in step 1508, an indication of the processing issue is received. In step 1510, an issue processing work flow is automatically identified. In step 1512, at least one of the worker resources is assigned to at least a portion of the issue processing work flow (e.g., the work flow identified in step 1510) for handling. In step 1514, a report is generated relating to the processing issue.

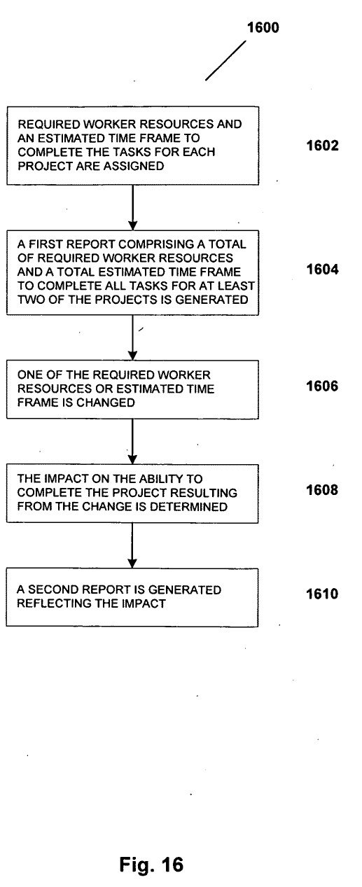

Referring to FIG. 16, a method 1600 for managing a plurality of document publishing projects, including a plurality of tasks associated with each project, is illustrated. In step 1602, required worker resources and an estimated time frame to complete the tasks for each project are assigned. In step 1604, a first report comprising a total of required worker resources and a total estimated time frame to complete all tasks for at least two of the projects is generated. In step 1606, at least one of the required worker resources or the estimated time frame is changed. In step 1608, the impact on an ability to complete the projects resulting from the change is determined. In step 1610, a second report is generated reflecting the impact.

Although the foregoing description is directed to the preferred embodiments of the invention, it is noted that other variations and modifications will be apparent to those skilled in the art, and may be made without departing from the spirit or scope of the invention.

We claim:

1. A method for managing a document publishing project, the method comprising:
(a) receiving document publishing project information; and
(b) identifying a plurality of work flows based on the information, each work flow comprising one or more tasks;
(c) assigning the one or more tasks to one or more worker resources;
(d) automatically receiving an indication of a processing issue associated with at least a portion of the information upon the worker resource identifying the processing issue;
(e) automatically identifying an issue processing work flow based on the processing issue;
(f) assigning to at least one of the worker resources at least a portion of the identified issue processing work flow; and
(g) generating a report comprising issue processing resolution information.

2. A method for managing a document publishing project, the method comprising:
(a) receiving document publishing project information; and
(b) upon receipt of the information, automatically identifying a plurality of work flows based on the information, each work flow comprising one or more tasks and each task associated with a capability for completing the task; and automatically identifying for each task a worker resource with the capability associated with the task; and
(c) creating a schedule for the project comprising a task sequence and a resource allocation.

3. The method of claim 2 further comprising:
(d) activating a first of the tasks to be completed;
(e) upon activating the first of the tasks, automatically commencing measurement of time metrics related to the completion of the tasks; and
(f) generating a report comprising the measured time metrics.

4. A method for managing a plurality of document publishing projects, each project comprising a plurality of tasks, the method comprising:
(a) assigning required worker resources and an estimated time frame to complete the tasks for each project;
(b) generating a first report comprising a total of required worker resources and a total estimated time frame to complete all tasks for at least two of the projects;
(c) changing at least one of the required worker resources and the estimated time
frame;
(d) determining an impact an ability to complete the projects resulting from the change;
(d) generating a second report reflecting the impact.

5. A method for managing a business process relating to one or more document publishing projects comprising:
(a) receiving document publishing project information;
(b) identifying a plurality of tasks for processing the information;
(c) storing an indicator for each said task in a storage medium;
(d) assigning to one or more worker resources at least one of the tasks, comprising associating an indicator for each said worker resource with the indicator for the assigned task and storing the association in the storage medium;
(e) recording a work start time and a work end time, and indicating one or more work pause period of the worker resource for the assigned task;
wherein the work start time is automatically indicated upon the worker resource commencing work for the assigned task and the work end time is automatically indicated upon the worker completing work for the assigned task;
(f) upon the indication of the work start time, automatically commencing measurement of an elapsed time to complete task, wherein the elapsed time to complete task comprises a difference between the work start time and the work end time;
(g) automatically calculating an execution time to complete task comprising a sum of worked time periods between the one or more work pause periods; and
(h) storing the elapsed time to complete task and the execution time to complete task for the assigned task in the storage medium.

6. The method of claim 5 further comprising:
(i) generating a report relating to the one or more projects.

7. The method of claim 5 wherein the information comprises at least one content item and wherein the plurality of tasks are identified based on a type of the content item.

8. The method of claim 5 wherein the report comprises at least one of a project-level report and a task-level report.

9. The method of claim 5 wherein the project-level report relates to worker resource utilization.

10. The method of claim 7 wherein the report comprises a content item-level report.

11. The method of claim 5 further comprising:
(i) identifying a processing issue with respect to at least certain of the information; and
(j) assigning the processing issue to at least one of the worker resources for resolution.

12. The method of claim 11 further comprising:
generating a report comprising at least one of an indication of the severity of the processing issue, an indication of whether the processing issue is resolved, and a processing issue resolution explanation.

13. A method for managing a business process relating document publishing project comprising:
(a) receiving document publishing project information, wherein the project information is arranged in accordance with a hierarchical structure, wherein the structure comprises a plurality of structure elements including at least one submission level each of which comprises one or more folders levels, wherein the folder levels each comprise one or more content item levels;
(b) maintaining in a storage medium at least one work flow, comprising one or more tasks, for the information associated with each of the structure elements;
(c) identifying one or more of the tasks based on the information; and
(d) assigning to one or more worker resources at least one of the tasks.

14. A graphical user interface for use in connection with managing document publishing project comprising:
a submission display area that displays document publishing project information arranged in accordance with a hierarchical structure, wherein the structure comprises a plurality of structure elements including at least one submission level, each of which comprises one or more folders levels, wherein the folder levels each comprise one or more content item levels; and
a content item display area that displays content item information associated with one of the structure elements selected in the submission display area;
wherein the content item display area allows an operator to view, for all content items in the selected structure element, task information associated with the project information.

15. The graphical user interface of claim 14 wherein the content items display area allows an operator to view content items associated with the selected structure element based on a characteristic of the content items.
